(19) United States
(12) Patent Application Publication
(10) Pub. No.: US 2014/0192949 A1
(43) Pub. Date: Jul. 10, 2014

(54) NUCLEAR REACTOR FUEL ELEMENT HAVING SILICON CARBIDE MULTILAYERED CLADDING AND THORIA-BASED FISSIONABLE FUEL

(71) Applicants: Herbert Feinroth, Silver Spring, MD (US); Gregory T. Markham, Bedford, VA (US); Eugene Shwageraus, Cambridge (GB); Julian F. Kelly, Oslo (NO)

(72) Inventors: Herbert Feinroth, Silver Spring, MD (US); Gregory T. Markham, Bedford, VA (US); Eugene Shwageraus, Cambridge (GB); Julian F. Kelly, Oslo (NO)

(73) Assignees: Thor Energy AS, Oslo (NO); Ceramic Tubular Products, LLC, Rockville, MD (US)

(21) Appl. No.: 14/126,614

(22) PCT Filed: Jun. 18, 2012
(86) PCT No.: PCT/US12/42981

§ 371 Date: Mar. 13, 2014

Related U.S. Application Data
(60) Provisional application No. 61/520,889, filed on Jun. 16, 2011.

(51) Int. Cl. G21C 3/07; G21C 3/10

(52) U.S. Cl. CPC G21C 3/07; G21C 3/10
USPC 376/451

(57) ABSTRACT

A nuclear fuel element for use in water-cooled nuclear power reactors. The fuel element includes a multilayered silicon carbide cladding tube. The multilayered silicon carbide cladding tube preferably includes an inner layer and a central layer. Also, in one embodiment, the ends further include hermetically sealed end caps. The cladding tube is sized to receive a stack of individual fissionable fuel pellets. In one embodiment, the fuel pellets comprise a mixture of thorium oxide and plutonium oxide.

### CROSS-REFERENCE TO RELATED APPLICATIONS

This application claims priority from U.S. Provisional Application No. 61/520,889, filed Jun. 16, 2011, the contents of which are hereby incorporated by reference in its entirety.

### STATEMENT AS TO RIGHTS TO INVENTIONS MADE UNDER FEDERALLY SPONSORED RESEARCH OR DEVELOPMENT

Work described herein may have been supported in part Department of Energy (DOE) Grant No. DE-SC0004225. The United States Government may therefore have certain rights in the inventions.

### FIELD

The present inventions relate generally to nuclear fuel elements for use in water-cooled nuclear power reactors and, more particularly, to a multilayered silicon carbide cladding tube adapted to receive a stack of individual thorium-based fissionable fuel pellets.

### BACKGROUND

Nuclear fuel elements are designed to produce fission heat in a nuclear power reactor. Fuel elements are sealed fuel rods containing stacks of ceramic pellets containing fissile material with these being clad and sealed usually in zirconium alloy tubes. A multiplicity of these individual fuel elements are first assembled into a fuel assembly that is inserted into the nuclear reactor pressure vessel and then used with other fuel assemblies for generating fission heat to drive a turbine to make electricity.

For several years there has been research on possible replacement of the zirconium alloy (zircaloy) cladding with a multi-layer silicon carbide cladding that has greater hardness, corrosion resistance and strength than zircaloy at high temperatures (above 500° C.), and better neutron transparency & moderation effect.

Multilayer silicon carbide cladding has been shown experimentally to be more resistant to damage during postulated reactor accidents, partly because it does not react violently and exothermically with water and release hydrogen, as does the zircaloy clad during Loss of Coolant Accidents, such as occurred at Three Mile Island in 1979, and Fukushima in 2011.

Such multilayer cladding is described in the following patent applications:

U.S. patent application Ser. No. 12/229,299, filed Aug. 21, 2008 to Feinroth et al. discloses a multi-layered ceramic tube for fuel containment barrier and other applications in nuclear and fossil power plants. The disclosure of this patent application and its cited references is hereby incorporated by reference in its entirety.

U.S. patent application Ser. No. 11/144,786 filed Jun. 6, 2005 to Feinroth et al. discloses a multi-layered ceramic tube for fuel containment barrier and other applications in nuclear and fossil power plants. The disclosure of this patent application and its cited references is hereby incorporated by reference in its entirety.

U.S. Provisional Patent Application Ser. No. 60/577,209 filed. Jun. 7, 2004 to Feinroth et al. discloses a multi-layered ceramic tube for fuel containment barrier and other applications in nuclear and fossil power plants the contents of which are hereby incorporated herein by reference in its entirety.

However, because the silicon carbide clad has a ceramic structure that is not susceptible to mechanical creep during operation, its behavior when operating with uranium oxide fuel leaves an insulating gap between the cladding and the uranium oxide fuel, leading to higher fuel temperatures and eventually to more fission gas release during long-term operation. Zircaloy cladding, on the other hand, creeps down onto the surface of the fuel pellets during the early months of operation, eliminating the insulating gap between fuel and cladding.

Also, the higher fuel centerline temperatures with silicon carbide cladding as compared to zircaloy cladding, may lead to reduced margin to fuel element melting during nuclear power plant transients, which could reduce the safety margin.

Also, for several years there has been research on possible replacement of the uranium dioxide fuel pellet with a fuel ceramic comprised largely of thorium dioxide (ThO₂, often referred to as “thorium oxide”) with an admixture of plutonium dioxide having an appropriate isotopic make-up to serve as a fissile driver. The plutonium dioxide components are derived from spent nuclear fuels via reprocessing and contains the isotopes Pu²³⁹ and Pu²⁴¹, which are fissile in a thermal neutron flux and thus provide the necessary reactivity to sustain the chain reaction. The fuel is designated ‘Th-MOX’, ‘thoria-plutonia’ or ‘(Th,Pu)O₂’ to indicate that the plutonium will mainly be in solid solution with the thorium dioxide. The thorium dioxide component is naturally occurring and is extremely robust in terms of its chemical, physical and thermal properties.

The resilience of (Th,Pu)O₂ ceramic to radiation and chemical damage means that it can safely reside in a reactor core for long periods; at least 8 to 10 years. This fact, together with the fact that some of the thorium converts to thermally fissile U²³³ during neutron irradiation offers two options for a thorium fuel designer: (i) the fuel is designed to sustain a chain reaction and provide energy in the reactor for a long burn-up period, by enhancing the ²³³U conversion ratio, and (ii) the thoria-plutonia fuel is designed to consume (i.e. destroy) a very large fraction of the plutonium it contains; more can be consumed as compared with conventional uranium-based Mixed Oxide (MOX) fuel. This represents a proliferation resistance advantage for thorium-based fuel.

Unfortunately, the zircaloy cladding used with fuel in today's reactors is only capable of operation for 4 to 5 years and hence inhibits the ability to take advantage of the long in-core residence capability of (Th,Pu)O₂ fuel ceramic. In fact, the nuclear regulators in the US and overseas generally limit the amount of burnup that can be allowed on zircaloy-clad fuel to 62 MWd/kg, peak burnup, which in effect determines the 4 to 5 year fuel lifetime. Hence, the advantages of higher burnup and/or greater plutonium destruction of thoria-plutonia fuels has not been achieved.

Thus, there remains a need for a new and improved nuclear fuel element for use in water-cooled nuclear power reactors which includes a multilayered silicon carbide cladding tube while, at the same time, is adapted to receive a stack of individual thorium-based fissionable fuel pellets. This provides significant improvement in the safety and efficiency of commercial nuclear power reactor operation by the combination of thorium oxide fuels that have higher melting temperatures and also better thermal conductivity than uranium oxide with a new cladding that is capable of long-term operation (e.g. 8 to 10 years) in a commercial light water reactor.

### SUMMARY

The present inventions are directed to a nuclear fuel element for use in water-cooled nuclear power reactors. The fuel element includes a multilayered silicon carbide cladding tube. The multilayered silicon carbide cladding tube preferably includes an inner layer and a central layer. Also, in one embodiment, the ends further include hermetically sealed end caps. The cladding tube is sized to receive a stack of individual fissionable fuel pellets. In one embodiment, the fuel pellets comprise a mixture of thorium oxide and plutonium oxide.

In one embodiment, the inner layer is a monolith layer. The inner monolith layer may be formed by chemical vapor deposition.

In one embodiment, the central layer is a composite of silicon carbide surrounded by a silicon carbide matrix. The central composite layer may include silicon carbide fibers. In addition, the silicon carbide fibers may be in the form of a tow that includes between about 500 and about 1600 fibers having between about 8 and about 14 microns in diameter. Also, the silicon carbide fibers may include a carbon interface coating thickness of between about 0.1 and about 1 micron.

In one embodiment, the fuel element further includes an outer monolith layer. The outer monolith layer may be formed by chemical vapor infiltration or by chemical vapor deposition. In addition, the outer monolith layer may have a thickness between about 3 and about 10 mils.

In one embodiment, the multilayer silicon carbide cladding tube is substantially formed of stoichiometric beta silicon carbide crystals that are resistant to damage by neutron radiation.

In one embodiment, the end caps are formed of high-density silicon carbide. Also, the end caps may be substantially formed of stoichiometric beta silicon carbide crystals that are resistant to damage by neutron radiation.

The multilayer silicon carbide cladding tube constructed according to the present inventions may be between about 1.5 and about 14 feet in length, with a tube wall thickness between about 20 and about 50 mils and with a tube outside diameter between about 0.25 and about 0.5 inches.

In one embodiment, the fuel pellets further include uranium 233 oxide substituted for the plutonium oxide and mixtures thereof.

In one embodiment, the fuel pellets include thorium oxide, plutonium oxide, uranium oxide, americium oxide, neptunium oxide, curium oxide and mixtures thereof.

In one embodiment, the fuel pellets include between about 1 wt. % and about 20 wt. % plutonium oxide and the balance thorium oxide.

Accordingly, one aspect of the present inventions is to provide a nuclear fuel element for use in water-cooled nuclear power reactors, the fuel element comprising: (a) a multilayered silicon carbide cladding tube; (b) a stack of individual fissionable fuel pellets, wherein the fuel pellets comprise a mixture of thorium oxide and plutonium oxide.

Another aspect of the present inventions is to provide an improvement to a nuclear fuel element for use in water-cooled, thorium-based nuclear power reactors, the improvement comprising: (a) a multilayered silicon carbide cladding tube, the multilayered silicon carbide cladding tube including (i) an inner layer and (ii) a central layer; and (b) hermetically sealed end caps.

Still another aspect of the present inventions is to provide a nuclear fuel element for use in water-cooled nuclear power reactors, the fuel element comprising: (a) a multilayered silicon carbide cladding tube, the multilayered silicon carbide cladding tube including (i) an inner layer and (ii) a central layer; (b) hermetically sealed end caps; and (c) a stack of individual fissionable fuel pellets, wherein the fuel pellets comprise a mixture of thorium oxide and plutonium oxide.

These and other aspects of the present inventions will become apparent to those skilled in the art after a reading of the following description of the disclosure when considered with the drawings.

### BRIEF DESCRIPTION OF THE DRAWINGS

FIG. 1 is a longitudinal, cross-sectional view of a nuclear reactor fuel element having silicon carbide cladding and thorium-based fuel constructed according to the present inventions;

FIG. 2 is a radial, cross-sectional view of the nuclear reactor fuel element having silicon carbide cladding and thorium-based fuel shown in FIG. 1 taken along lines 2-2;

FIG. 3 is an enlarged, radial, cross-sectional view of the nuclear reactor fuel element having silicon carbide cladding and thorium-based fuel shown in FIG. 2;

FIG. 4 is a graph illustrating Maximum Centerline Fuel Temperature for Zircaloy and SiC clad fuel rods; and

FIG. 5 is a graph illustrating Single-batch and Three Batch Discharge Fuel Burnup as a Function of Initial Plutonium Content.

### DETAILED DESCRIPTION OF EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

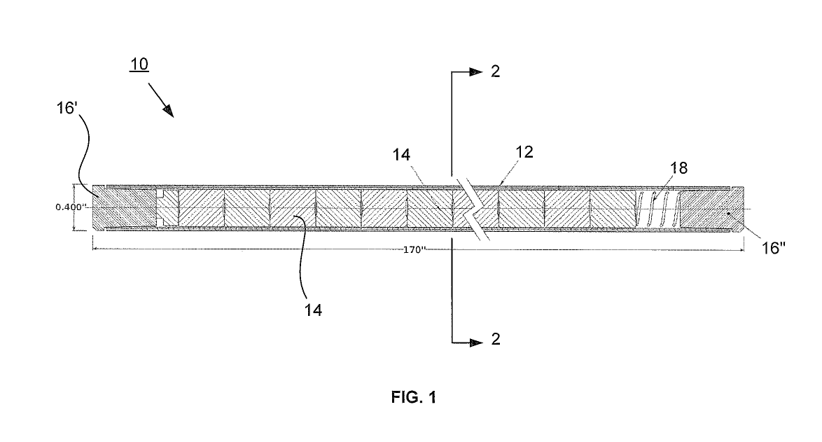

Referring now to the drawings in general and FIG. 1 in particular, it will be understood that the illustrations are for the purpose of describing a preferred embodiment of the inventions and are not intended to limit the inventions thereto. As best seen in FIG. 1, a nuclear fuel element, generally designated 10, is shown constructed according to the present inventions. FIG. 1 is a longitudinal, cross-sectional view of the SiC clad thoria-plutonia fuel element that is the subject of the present inventions.

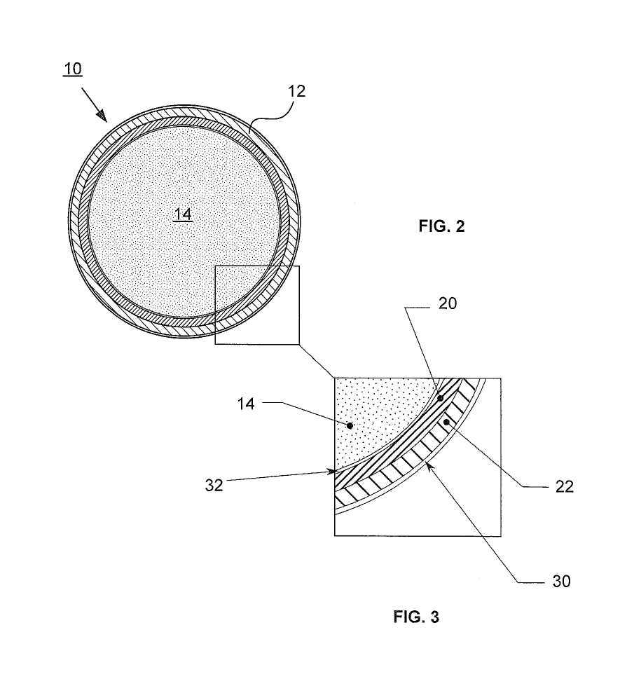

As shown in FIG. 1, the fuel element 10 is a tubular structure, generally about 170 inches long and 0.4 inches diameter. Variations exist for different types of water reactors, where the length can be as short as 18 inches, and the diameter can be as large as about 0.5 inches. The fuel element 10 includes the following parts as shown on FIG. 1:
Part A. Fuel Pellets—About 440 sintered thoria-plutonia pellets 14 of high density (95% of theoretical density) axially stacked within the tube 12, and containing from 5% to 20% by weight of plutonium oxide, and 80% to 95% of thorium oxide. In a typical case, the pellets 14 are about 0.350″ in diameter and about 0.350″ long, Variations exist where the number of pellets 14 can be as few as 40 per fuel element 10, and with diameters and lengths as high as 0.5 inches
Part B. End Plugs—Two end plugs 16′, 16″ also made from dense silicon carbide, one at each end of the tube 12, and sealed to the tube 12 to contain fission gases that are released from the fuel pellets 14 during irradiation. Each end plug is about 0.4 inches in diameter and 1 to 1.5 inches long
Part C. Multilayered Silicon Carbide Tube—A hollow three-layered SiC cladding tube 12 that is 170 inches long, 0.356 inches inside diameter, 0.035 inches in thickness, and 0.426 inches outside diameter. The makeup of the internal structure of the multi-layered cladding tube 12 is presented in FIG. 2.
Part D. Plenum Spring—A helical spring 18, about 0.035 inches in outside diameter, and about 15 inches long, inserted into one end of the Part C cladding tube 12 to retain the fuel pellets 14 in place during loading and handling. The spring 18 is generally made of Inconel® metal alloys. In some applications, the spring 18 is not used and the space is filled with pellets 14.

Turning now to FIG. 2, there is shown a radial, cross-sectional view of the fuel element 10 taken along lines 2-2 showing the makeup of the multilayered cladding 12. The fuel element 10 includes the following parts as shown on FIG. 2:
Part A—is the thoria-plutonia fuel pellets 14 also shown in FIG. 1
Part E—is the dense SiC monolith 20, the inside layer of the multilayered tube 12, with density greater than 99% to ensure hermeticity to retain fission gas. It is generally made via a chemical vapor deposition process to ensure high quality and beta phase crystals to minimize irradiation growth. Thickness is about 0.014 inches.
Part F—is the SiC—SiC composite layer 22 designed to provide extra strength and a graceful failure mode of the multilayered tube 12. It is made of helical wound stoichiometric SiC fibers 24 (about 12 microns in diameter, coated with a layer of carbon 28 about 0.2 microns in thickness) and infiltrated with a matrix 26 of vapor deposited SiC using the Chemical Vapor Infiltration process. The thickness of the part F composite layer 22 is about 0.014 inches.
Part G—is the SiC environmental barrier layer 30, made of dense SiC deposited via the Chemical Vapor Deposition process, and providing a robust defense against corrosion of the tube 12 during long periods of operation in the reactor coolant water. The thickness of part G is generally about 0.007″
Gap H—is a gas space 32 between the outside of the thoria-plutonia pellets 14, Part A, and the inside monolith 20, Part E that is needed to allow assembly of the pellets 14 into the cladding tube 12. Without this gap 32, it would be very difficult to assemble the pellets 14 into the cladding tube 12. However, as previously discussed, the existence of this gap 32 during reactor operation serves as a thermal insulator, causing a higher temperature of the fuel pellets 14 than would otherwise occur without the gap 32.

In one embodiment, the SiC fuel cladding tube 12 shown in FIGS. 1-3 consists of three layers 20, 22 and 30, each with a different primary function.

The inner layer 20 is dense (>99% of theoretical density) pure beta phase stoichiometric silicon carbide monolith made via the chemical vapor deposition process to preserve purity and assure high density. The absence of significant porosity assures that the tube 12 is leak tight, and will contain fission product gases evolved during normal reactor operations including operational transients. In one embodiment, the inner layer 20 is about 0.014 inches thick, about 0.360 inches in outside diameter, and up to 170 inches long. For other applications, it can be as short as 18 inches long (the length of fuel elements in the CANDU heavy water reactors), with diameters ranging from 0.250 inches to 0.500 inches.

The central layer 22 is a ceramic composite consisting of high purity beta phase dense stoichiometric silicon carbide fibers 24, each with a nominal diameter of 10 microns, (ranging from 8 to 14 microns in diameter), formed into a tow consisting of a nominal 1000 fibers, (ranging from 500 to 1500 fibers per tow) with the tow wound in helical fashion around the inner monolith 20. Each fiber 24 is coated with a thin carbon interface coating 28 of a nominal 0.2 microns in thickness, (ranging from 0.1 microns to 1 micron) and then the tow is wound around the inner monolith layer 20 in helical geometry, creating one or more layers, and then the space between the tows is infiltrated with beta phase SiC vapor using the chemical vapor infiltration process to create a matrix 26, and a composite that is not brittle, and instead retains a graceful failure mode.

The composite behavior is believed to be due to the carbon interface layer 28 allowing the fibers 24 to slip within the matrix 26 when subject to mechanical loading, thus assuring a stress strain behavior similar to metals rather than brittle ceramics. This feature allows the multilayered tube 12 to serve as a robust clad material that retains its geometry and solid fuel containment barrier even during severe accidents that could cause the inner monolith to crack and release gases during severe accident conditions.

Although the composite layer 22 provides the needed robustness, it does contain some porosity (10 to 15%) as the matrix infiltration technique does not fill in all the spaces between the fibers 24. Hence it is not hermetic and is not able to contain the fission gases that are released during irradiation. The separate inner layer 20 serves as the primary gas containment vessel.

The composite layer 22 also serves to reinforce the pressure containing capability of the inner monolith, allowing the combination of monolith layer 20 and composite layer 22 to retain internal pressures up to 8000 psi, as compared to pressures of less than 5000 psi that would be contained by the inner monolith 20 alone. The central layer 22 is also about 0.014 inches in thickness, with some variation allowing the thickness to be about 0.022 inches. Length of the preferred application is about 170 inches. Outside diameter is about 0.400 inches.

The outer layer 30 is provided as a corrosion barrier, and is a dense (>99% of theoretical) beta phase silicon carbide layer deposited via the chemical vapor deposition method. The thickness of the outer layer 30 is a nominal 0.007 inches, but can range from 0.003 inches to 0.010 inches depending on the application. Tests in the water-cooled loop of the MIT Research Reactor indicate the capability of the outer environmental barrier layer 30 to assure a durability of the cladding tube 12 in typical reactor coolant (300° C.) of at least 8 years.

Preferably, the silicon carbide used in the multilayered cladding tube 12 is high purity stoichiometric beta phase material because extensive tests have shown that other forms of silicon carbide, containing minor impurities and/or alpha phase material do not retain as much strength during irradiation, which would not be as desirable for reactor application.

Recent tests at Ceramic Tubular Products show that replacing zircaloy cladding with SiC ceramic cladding would reduce the amount of heat generated, and the amount of flammable hydrogen generated, during Loss of Coolant Accidents such as occurred at Three Mile Island and Fukushima, by factors of 500 or more, thus reducing accident severity, minimizing release of radioactive fuel, and avoiding the loss of many billions of dollars of investment.

The multilayered silicon carbide cladding tube 12 also has the capability of containing nuclear fuel that is taken to high burnups of over 100 MWd/kg of initial heavy metal as compared to a maximum of about 60 MWd/kg that is achievable for zirconium alloy clad fuel. In addition, because of its high temperature resistance, the SiC multilayered cladding tube 12 has the potential for allowing increased power density, thus improving the economics of nuclear power generation.

Recent evaluation of the predicted behavior of the multilayered cladding in a typical commercial nuclear reactor has identified an important property with regard to long-term integrity. Contrary to metal cladding, the SiC multilayered cladding tube 12 is not expected to creep when subject to mechanical loading. Hence, the gap 32 between the inner cladding layer 20 and the internal fuel pellets 14, generally about 0.003 inches radial clearance to allow assembly, is likely to remain through much of the fuel lifetime. With metal cladding, the gas gap 32 is mitigated during early operation because the reactor pressure causes the cladding to creep down onto the outside of the fuel pellets 14.

The gas gap 32 between pellets 14 and the silicon carbide cladding 12 is expected to act as a thermal insulator, leading to internal fuel temperatures that are up to 400° C. higher than if the fuel were clad with zirconium alloy. When operating at these higher temperatures, traditional uranium oxide fuel is expected to degrade more quickly during reactor operation, leading to more rapid migration and release of fission gases within the sealed clad containment barrier, thus leading to higher internal pressures and shorter fuel life.

The more rapid fission gas release and fission gas pressure buildup within the ceramic clad fuel would be expected to limit the amount of energy, or burnup that would otherwise be achieved with the new clad material, and hence limit its economic potential. The higher fuel temperatures also could reduce the margin to melting during accidental power transients, thus limiting the power rating of the ceramic clad fuel element and this also could limit its economic potential.

The present inventions replace the uranium oxide fuel within the SiC cladding with a more robust ceramic fuel based on thorium dioxide (ThO₂, also referred to as thorium oxide or “thoria”). The required fissile component for the fuel is plutonium in the form of its dioxide (PuO₂, or “plutonia”) and which contains enough of the fissile isotopes (²³⁹Pu and ²⁴¹Pu) such that an economically desirable burnup can be achieved. This fuel type can be described and designated as a “thoria-plutonia” fuel.

Thoria has a higher melting temperature (3200° C.) as compared to 2800° C. for uranium oxide. This provides greater margin to melting which is a concern during transients and accidents. Also the thermal conductivity of thoria-plutonia fuel is higher than uranium oxide. And finally, the thoria-based fuel has a better ability to retain fission gases in the fuel matrix during irradiation due to the electrostatic potential in the thoria lattice and the nature and distribution of lattice defects that form during neutron irradiation. These properties (higher melting temperature, improved thermal conductivity, improved fission gas retention), when combined, allow the SiC clad thoria-plutonia fuel to achieve much higher burnup than can be attained with current uranium oxide fuel clad with zircaloy.

Thus, while thoria-plutonia fuel can operate safely and effectively with ordinary zirconium alloy cladding, as has been demonstrated in European experiments, it does not have the higher burnup potential due to the inherent degradation of zirconium metal in the LWR environment (resulting from radiation embrittlement, corrosion and other chemical processes).

Other advantages of thoria fuels, as reported by the International Atomic Energy Agency (IAEA) include the following:
Thorium is 3 to 4 times more abundant than uranium and is widely distributed in nature as an easily exploitable resource. Thorium fuels, therefore complement uranium fuels and ensure the long-term sustainability of nuclear power.
Thorium fuel cycles will, in general, entail the production of nuclear energy with less waste that is of lower long-term radiotoxicity.

Due to the neutronic properties (such as non-fissile and fissile absorption cross sections) of the relevant nuclides, it is possible to achieve fissile breeding with thermal neutrons in thorium fuels. Thorium-MOX fuels could be optimized to give high ²³³U conversion factors, if that became desired at some point in the future. In any case, fissile ²³³U generated in thorium-MOX fuels could conceivably be recovered in the future when economic feasibility, proliferation risk concerns and chemical separation technology readiness issues combine to make this a viable strategy (not currently the case). It is noteworthy that ²³³U is superior to plutonium as a fissile driver material for LWR fuel since it is much more amenable to multiple cycling in thermal reactors.
Thorium dioxide is non-oxidizable and is chemically inert. It has higher radiation resistance than uranium dioxide. Combined with its favorable thermo-physical properties, ThO₂based fuels are expected to have better in-pile performance in both normal and postulated accident scenarios. These properties are also highly advantageous in the contexts of the long-term interim storage and permanent repository disposal of spent ThO₂ based fuels.

Research by Carpenter at the Massachusetts Institute of Technology in 2010 describes the behavior of uranium oxide fuel in a typical commercial PWR when clad with silicon carbide as compared to zircaloy. The Seabrook Nuclear Plant was used as reference core design. A case was analyzed with 1500 days exposure to 70 MWd/kg average burnup for the peak rod, with the average linear heat generation rate of that peak rod at beginning of life of 8.5 kw/ft, and gradually dropping to 4 kw/ft at end of life, typical of operation in a 3 batch PWR reload scenario. A modified version of the computer code FRAPCON SiCv2, described by Carpenter, was used for the analysis.

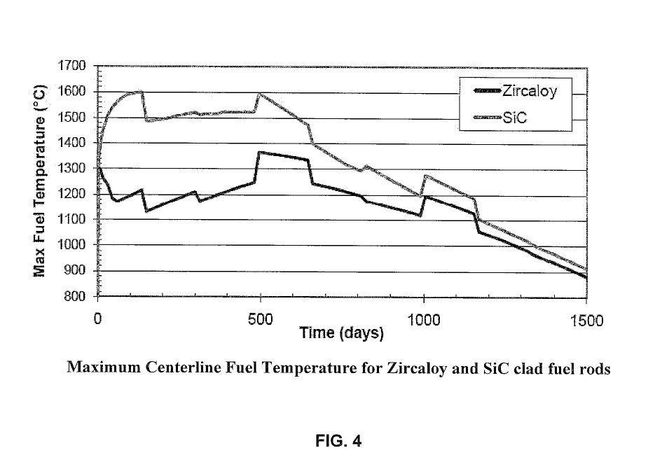

FIG. 4 portrays the results of Carpenter's calculations. Note that the peak fuel temperature of SiC clad conventional Uranium Oxide (UO₂) fuel reaches a maximum of 1600° C. during steady state operation early in life, as compared to about 1200° C. for zircaloy clad conventional UO₂ fuel. In addition to the additional fission gas release, and resulting internal fuel rod pressure resulting from this higher temperature, the margin to melting of the UO₂ fuel (melting temperature of 2800° C.) during accidental transients and accidents is only 1200° C., as compared with about 1600° C. with zircaloy clad. This smaller margin could be used up during design basis transients, leading to centerline melting, an unacceptable condition. Regulations and safe utility operational procedures require that there be sufficient margin to melting during such transients to avoid potential fuel damage and release to coolant.

By replacing the uranium oxide fuel with a higher melting temperature (3350° C.) thoria-based fuel according to the present inventions, the margin between peak steady state centerline temperature and fuel melting temperature with SiC cladding is increased to 1750° C.

The applicants have evaluated the feasibility of a typical LWR nuclear reactor core design in which zirconium alloy clad uranium oxide fuel is replaced with SiC-clad Thorium-MOX fuel. The applicants calculated that fuel burnups greater than 100 MWD/kg are feasible with reactor-grade plutonium concentrations of 19% (element basis, with the Pu being comprised of ˜65% fissile isotopes) and that such fuel designs appear to have acceptable reactivity behavior. Applicants also quantified the impact of SiC cladding and high burnup on the residual plutonium content in discharged fuel and evaluated a basic set of reactivity feedback coefficients.

Calculations were performed with the two dimensional lattice transport code ‘BOXER’. The assembly transport calculations were performed in 70 energy groups using a cross section library mostly based on the JEF-1 evaluated data file. The BOXER code has been previously validated against other state of the art computer codes and experimental data and found capable of modeling Thoria-Plutonia fuel in LWRs with accuracy adequate for the purposes of this study.

Standard 17×17 pin PWR fuel assembly dimensions, power density and operating conditions were used. The core average parameters were calculated by applying the Linear Reactivity Model to the results of 2D fuel assembly infinite lattice burnup calculations. A typical 3% core leakage reactivity worth and 3-batch refueling scheme were assumed. A reactor-grade plutonium isotopic vector was taken from a typical LWR discharge fuel with 4.5% initial enrichment, 50 MWd/kg burnup and 10 years of decay following discharge.

Three cases were analyzed:
Fuel assembly with Zircaloy cladding of standard thickness (0.057 cm),
Fuel assembly with SiC cladding of standard thickness,
Fuel assembly with thicker SiC cladding (0.089 cm) to account for possible manufacturing constraints. The outer pin diameter and the gap thickness were kept the same, which translated into slightly reduced fuel pellet diameter (0.757 cm).

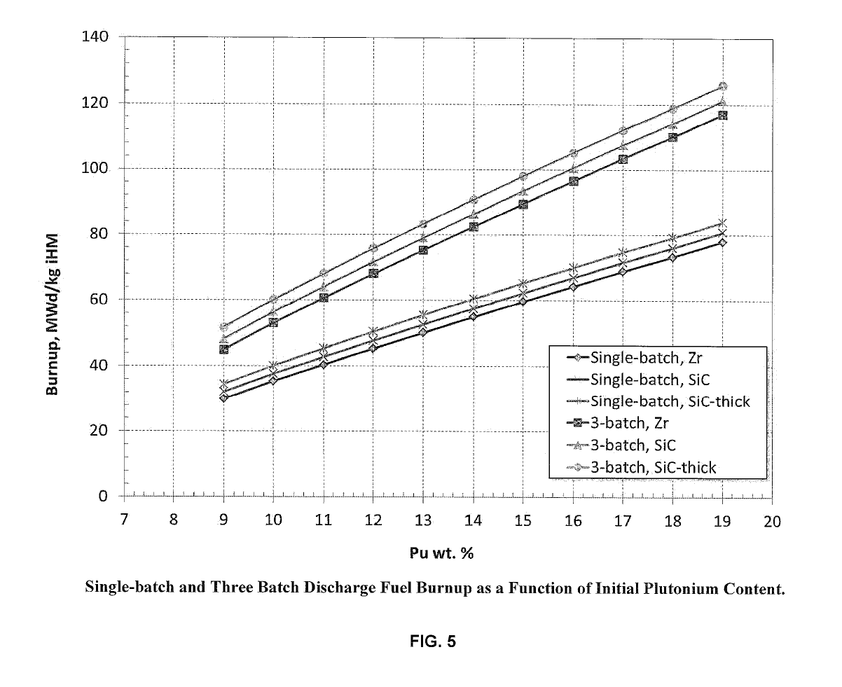

Selected results from the analyses are presented in FIG. 5. With an initial Pu loading of 19%, a batch average burnup on the order of 126 MWd/kg can be achieved, which is greater by more than a factor of 2 than is feasible with zircaloy clad UO₂ fuel with 5% enrichment. This would lead to a major reduction in the amount of spent fuel produced per kWh in a typical large nuclear power plant. To achieve such burnup, at a typical commercial reactor power density, would require three 32.7 months cycles (8.2y total), which is well beyond the reach of zircaloy clad fuel.

Higher fuel burnup improves the extent of plutonium consumption in thorium-plutonic fuel. The residual total plutonium fraction is reduced from about 50% to 43% of the initial loading by increasing the fuel burnup from 50 to 100 MWd/kg. This is because of the steady buildup of U-233 so that high burnup results in higher energy production per kg of initial Pu through more efficient in-situ burning of U-233. Additional moderation due to the use of thick SiC cladding helps to reduce the residual Pu fraction by an additional 1 to 2%.

The calculated moderator temperature, Doppler and soluble boron reactivity feedback coefficients were found to be within the range of typical U—Pu MOX fuel and slightly more favorable for the thick SiC clad fuel cases.

In addition to the potential for achieving longer cycles and reduced waste generation, a combination of thorium-plutonia fuel with SiC cladding at high burnup beyond 100 MWd/kg provides a number of additional features:
The buildup of ²³³U generated from ²³²Th is fairly slow and requires long in-core residence time for the fuel to produce significant fraction of energy from fissions of ²³³U. Therefore, high burnup allows better utilization of the initial fissile plutonium driver material.
The residual plutonium in spent SiC-clad thorium-plutonia fuel is low in fissile isotopes, and the higher the burnup, the lower the fissile content. As such, the spent fuel has high inherent proliferation resistance.
SiC cladding has lower neutron absorption and better moderating power than conventional Zircaloy cladding. Thus it leads to a non-negligible reactivity addition to the thorium plutonia fuel. As a result, even higher burnup can be achieved using the same initial Pu loading and this again contributes to the better Pu utilization and smaller residual Pu fraction than with Zircaloy cladding. In this regard, the fuel with thick SiC cladding appears to have superior performance to the fuel with cladding of standard dimensions, even though the initial heavy metal loading was reduced in the former case.
A high plutonium loading, required for achieving high burnup, results in significant neutron spectrum hardening and a corresponding reduction in the worth of reactivity control materials. The superior moderation properties of SiC cladding and, in particular, thick SiC cladding, notably mitigate that effect.
An additional advantage of Thoria-Plutonia, as compared to U—Pu-MOX fuel relates to the void reactivity, an important parameter affecting reactor safety during accidents Thoria-Plutonia can allow much higher Pu loading (which is required to achieve high burnup) than U—Pu MOX without compromising void reactivity coefficient.

Although plutonia is described in one embodiment as the fission driver for the present inventions, other fission drivers can also be used. Specifically, uranium 233, if it is separated from irradiated thoria-based fuel for recycle, can be combined with fresh thorium oxide, fabricated into fuel pellets, loaded into silicon carbide multilayered cladding, and achieve high burnup and acceptable fuel performance.

Another embodiment, which can also achieve high burnup and acceptable fuel performance, is to use other transuranics derived from reprocessing of spent light water reactor fuel, as the main fission driver. These transuranics include americium oxide, neptunium oxide, and/or curium oxide. These can be used individually, or in mixtures, with the mixtures containing plutonium oxide, or not, depending on the reprocessing and separations technologies in commercial use.

The chemical interaction between thoria-based ceramic pellets and the silicon carbide cladding at reactor operating and accident temperatures was tested by the applicants since such conditions could result in cladding failures in operation.

A number of reactor grade thoria pellets were acquired, similar to pellets that had undergone irradiation testing in a Canadian test reactor. The thoria pellets were pressed against silicon carbide wafers and exposed in a furnace at temperatures of 1200° C. and 1400° C., well above the maximum allowed clad temperatures during accidents in today's licensed reactors. Exposure runs were made for periods up to 8 hours.

Negligible mass change was noted in the thoria samples. Mass changes in the SiC samples were consistent with the oxide layer growth only. No bonding between the materials was noted suggesting that no interaction occurred between the materials. These temperatures and exposure times are far greater than current operating or accident conditions expected in commercial nuclear reactors. This data indicates that the materials are compatible at reactor fuel operating and accident temperatures.

Certain modifications and improvements will occur to those skilled in the art upon a reading of the foregoing description. It should be understood that all such modifications and improvements have been deleted herein for the sake of conciseness and readability but are properly within the scope of the following claims.

1-5. (canceled)

6. In a nuclear fuel element for use in water-cooled, thorium-based nuclear power reactors, the improvement comprising:
(a) a multilayered silicon carbide cladding tube, said multilayered silicon carbide cladding tube including (i) an inner layer and (ii) a central layer; and
(b) hermetically sealed end caps, wherein said end caps are formed of high-density silicon carbide.

7. The fuel element according to claim 6, wherein said inner layer is a monolith layer.

8. The fuel element according to claim 7, wherein said inner monolith layer is formed by chemical vapor deposition.

9. The fuel element according to claim 6, wherein said central layer is a composite of silicon carbide surrounded by a silicon carbide matrix.

10. The fuel element according to claim 9, wherein said central composite layer includes silicon carbide fibers.

11. The fuel element according to claim 10, wherein said silicon carbide fibers are in the form of a tow that includes between about 500 and about 1600 fibers having between about 8 and about 14 microns in diameter.

12. The fuel element according to claim 11, wherein said silicon carbide fibers include a carbon interface coating thickness of between about 0.1 and about 1 micron.

13. The fuel element according to claim 6, further including an outer monolith layer.

14. The fuel element according to claim 13, wherein said outer monolith layer is formed by chemical vapor infiltration or by chemical vapor deposition.

15. The fuel element according to claim 13, wherein said outer monolith layer has a thickness between about 3 and about 10 mils.

16. The fuel element according to claim 6, wherein said multilayer silicon carbide cladding tube is substantially formed of stoichiometric beta silicon carbide crystals that are resistant to damage by neutron radiation.

17. (canceled)

18. The fuel element according to claim 6, wherein said end caps are substantially formed of stoichiometric beta silicon carbide crystals that are resistant to damage by neutron radiation.

19. The fuel element according to claim 6, wherein said multilayer silicon carbide cladding tube is between about 1.5 and about 14 feet in length, with a tube wall thickness between about 20 and about 50 mils and with a tube outside diameter between about 0.25 and about 0.5 inches.

20. A nuclear fuel element for use in water-cooled nuclear power reactors, said fuel element comprising:
(a) a multilayered silicon carbide cladding tube, said multilayered silicon carbide cladding tube including (i) an inner layer and (ii) a central layer;
(b) hermetically sealed end caps, wherein said end caps are formed of high-density silicon carbide; and
(c) a stack of individual fissionable fuel pellets, wherein said fuel pellets comprise a mixture of thorium oxide and plutonium oxide.

21. The fuel element according to claim 20, wherein said fuel pellets further include uranium 233 oxide substituted for the plutonium oxide and mixtures thereof.

22. The fuel element according to claim 21, wherein said fuel pellets include thorium oxide, plutonium oxide, uranium oxide, americium oxide, neptunium oxide, curium oxide and mixtures thereof.

23. The fuel element according to claim 20, wherein said fuel pellets include between about 1 wt. % and about 20 wt. % plutonium oxide and the balance thorium oxide.

24. The fuel element according to claim 20, wherein said fuel pellets are sized to be received within said cladding tube.

25. The fuel element according to claim 20, wherein said inner layer is a monolith layer.

26. The fuel element according to claim 25, wherein said inner monolith layer is formed by chemical vapor deposition.

27. The fuel element according to claim 20, wherein said central layer is a composite of silicon carbide surrounded by a silicon carbide matrix.

28. The fuel element according to claim 27, wherein said central composite layer includes silicon carbide fibers.

29. The fuel element according to claim 28, wherein said silicon carbide fibers are in the form of a tow that includes between about 500 and about 1600 fibers having between about 8 and about 14 microns in diameter.

30. The fuel element according to claim 29, wherein said silicon carbide fibers include a carbon interface coating thickness of between about 0.1 and about 1 micron.

31. The fuel element according to claim 20, further including an outer monolith layer.

32. The fuel element according to claim 31, wherein said outer monolith layer is formed by chemical vapor infiltration or by chemical vapor deposition.

33. The fuel element according to claim 31, wherein said outer monolith layer has a thickness between about 3 and about 10 mils.

34. The fuel element according to claim 20, wherein said multilayer silicon carbide cladding tube is substantially formed of stoichiometric beta silicon carbide crystals that are resistant to damage by neutron radiation.

35. (canceled)

36. The fuel element according to claim 20, wherein said end caps are substantially formed of stoichiometric beta silicon carbide crystals that are resistant to damage by neutron radiation.

37. The fuel element according to claim 20, wherein said multilayer silicon carbide cladding tube is between about 1.5 and about 14 feet in length, with a tube wall thickness between about 20 and about 50 mils and with a tube outside diameter between about 0.25 and about 0.5 inches.
